(19) United States
(12) Patent Application Publication
(10) Pub. No.: US 2020/0364695 A1
(43) Pub. Date: Nov. 19, 2020

(54) NEAR FIELD COMMUNICATION RESOURCE TRANSFER

(71) Applicant: BEIJING SANKUAI ONLINE TECHNOLOGY CO., LTD, Beijing (CN)

(72) Inventors: Feng LIU, Beijing (CN); Qi ZHAO, Beijing (CN)

(21) Appl. No.: 16/987,143

(22) Filed: Aug. 6, 2020

Related U.S. Application Data
(63) Continuation-in-part of application No. PCT/CN2018/121153, filed on Dec. 14, 2018.

(30) Foreign Application Priority Data
Feb. 7, 2018 (CN) 201820221147.7

(51) Int. Cl. G06Q 20/32; G06Q 20/38; H04B 5/00; H04W 4/80; G06F 13/42

(52) U.S. Cl. CPC G06Q 20/3278; G06Q 20/3227; G06Q 20/382; G06F 2213/0016; H04W 4/80; G06F 13/4282; H04B 5/0031

(57) ABSTRACT

A resource transfer terminal comprises a housing and a near field communication module supported by the housing. The near field communication module is configured to be operable in a passive mode, and sense a resource transfer signal transmitted by a user device, and operates in response to the resource transfer signal. The near field communication module is provided with a resource transfer key and/or a verification key.

### CROSS-REFERENCE TO RELATED APPLICATIONS

This patent application is a continuation-in-part of an international application No. PCT/CN2018/121153, filed on Dec. 14, 2018 and entitled “NEAR FIELD COMMUNICATION PAYMENT.” This international application claims priority to Chinese Patent Application No. 201820221147.7, filed on Feb. 7, 2018 and entitled “PAYMENT MERCHANT TERMINAL AND PAYMENT SYSTEM.” Both of these applications are incorporated herein by reference in its entirety.

### TECHNICAL FIELD

This application relates to the technical field of near field communication, and more particularly to a resource transfer terminal, a resource transfer system and a resource transfer method.

### BACKGROUND

With the development of near field communication technology and Internet technology, near field communication (NFC) payment is more and more widely applied. NFC payment terminals have gradually been used, such as bus POS machines, unionpay POS machines and campus POS machines.

### SUMMARY

An embodiment of this application provides a resource transfer terminal having advantages of small size, low cost, flexibility in use and feasibility to be widely deployed at various use environments.

In one aspect, an embodiment of this application provides a resource transfer terminal, including:

a housing; and

a near field communication module, supported by the housing, configured to operate in a passive mode and provided with a resource transfer key and/or a verification key.

The near field communication module operates under the control of a sensed resource transfer signal.

In another aspect, an embodiment of this application provides a resource transfer system, including a resource transfer terminal, a first management terminal, a second management terminal and a resource transfer management server.

The first management terminal reads any one or more of authentication information and a transfer-in party signature stored in the resource transfer terminal, and a resource transfer order generated by the resource transfer terminal through near field communication.

The second management terminal reads the resource transfer order stored by the resource transfer terminal through near field communication or Bluetooth communication, and writes resource transfer-related information into the resource transfer terminal.

The resource transfer management server performs data transmission with the first management terminal and the second management terminal through a network.

### BRIEF DESCRIPTION OF THE DRAWINGS

To describe the technical solutions in the embodiments of this application more clearly, the following briefly introduces the accompanying drawings required for describing the embodiments of this application. Apparently, the accompanying drawings in the following description show merely some embodiments of this application, and a person of ordinary skill in the art may still derive other drawings from the accompanying drawings without creative efforts.

FIG. 1 is a schematic structure diagram of a resource transfer terminal provided by an embodiment of this application.

FIG. 2 is a schematic structure diagram of another resource transfer terminal provided by an embodiment of this application.

FIG. 3 is a schematic structure diagram of another resource transfer terminal provided by an embodiment of this application.

FIG. 4 is a schematic structure diagram of a further another resource transfer terminal provided by an embodiment of this application.

FIG. 5 is a schematic structure diagram of a resource transfer system provided by an embodiment of this application.

FIG. 6 is a flow diagram of a resource transfer method provided by an embodiment of this application.

### DETAILED DESCRIPTION

The following clearly and completely describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

### Embodiment 1

According to an embodiment illustrated in FIG. 1, a resource transfer terminal is provided. The resource transfer terminal in the embodiment of this application refers to the terminal used to accept the resource transfer order during the resource transfer process. The resource transfer refers to transferring the resources from a resource transfer-out party to a resource transfer-in party, and the resources include, but not limited to, currency, bitcoin, virtual gifts, coupons and other types. In one example, the resource transfer-out party is a certain user, the resource transfer-in party is a merchant, and the user buys goods from the merchant. The resource transfer refers to the transfer of the money paid for purchased goods from the user to the merchant. In another example, the resource transfer-out party is the first user and the resource transfer-in party is the second user. The resource transfer refers to the transfer of money from the first user to the second user. In one example of the resource transfer terminal, the resource transfer terminal is a payment merchant terminal which is used by a merchant to receive a payment order from a user. As shown in FIG. 1, the resource transfer terminal 10 includes a housing 11; and a near field communication module 12 disposed in the housing 11 and provided with a resource transfer key and/or a verification key. In one example, the resource transfer key is a payment key or a verification key. The near field communication module 12 is operable or operates in a passive mode, and operates under the control of a sensed resource transfer signal such as a payment signal from a device of a user or a resource transfer-out party or operates in response to the sensed resource transfer signal.

In some embodiments, the resource transfer signal is sent by a first management terminal held by a user, or sent by a second management terminal held by a merchant, or sent by another device. In some embodiments, the resource transfer terminal and the second management terminal are separate devices owned by a merchant. For example, the resource transfer terminal is a card or a device owned by the merchant and the second management terminal is a cash register owned by the merchant.

The near field communication module can operate in an active mode or a passive mode. During operation in the active mode, all electric power required during communication with a passive device can be provided through an RF-field generated inside. During operation in the passive mode, electricity consumption can be greatly reduced. In this application, illustration is performed by taking the operation of the near field communication module 12 in the passive mode as an example.

In some embodiments, the near field communication module 12 includes an integrated chip. The integrated chip includes an embedded secure element (eSE) chip, a contactless frontend (CLF) chip (also called as an NFC controller) and a near field communication (NFC) antenna, which are integrated. In some embodiments, the eSE chip, the CLF chip and the NFC antenna are separate and independently encapsulated. The near field communication module 12 is a circuit module formed by the eSE chip, the CLF chip and the NFC antenna. In some embodiments, the eSE chip is connected with the CLF chip through an inter-integrated circuit (I2C) or serial peripheral interface (SPI), and the CLF chip is connected with the NFC antenna through inductance.

The CLF chip is a control chip with an NFC contactless communication function, and is in charge of controlling I/O transmission of contactless information, including modulation and demodulation of radio frequency signals, protocol processing of contactless communication and the like. The CLF chip is connected with the NFC antenna through inductance. The eSE chip has main functions of securely storing applications and data and providing secure computing services for outside. The eSE chip further communicates with an external read-write device through the CLF chip to realize security of data storage and trading processes. The NFC antenna has main functions of realizing transmission and reception of a radio frequency signal.

In some embodiments, the near field communication module 12 operates in the passive mode, and does not need to be powered by a power source. After a resource transfer signal is sensed, the near field communication module 12 may automatically generate an induced voltage, and starts and operates under the effect of the induced voltage. For example, when a user performs a read-write operation on the resource transfer terminal 10 through a first management terminal (such as a mobile phone with a built-in near field communication module), the near field communication module 12 senses an electromagnetic signal transmitted by the built-in near field communication module of the first management terminal to generate an induced voltage, and starts and operates under the effect of the induced voltage. The electromagnetic signal is a resource transfer signal. The near field communication module 12 executes resource transfer-related operations according to data carried by the resource transfer signal and data such as a resource transfer key and/or a verification key stored by the near field communication module 12 itself.

For example, when the data carried by the resource transfer signal includes a user identifier and an instruction of obtaining authentication information of a resource transfer-in party, the near field communication module 12 outputs stored authentication information, and stores the user identifier. The user identifier is used to express identity of a user as a resource transfer-out party, and is, for example, a user account, a mobile phone number of the user, etc. The authentication information is used to describe information of an owner of the resource transfer terminal. For example, when the authentication information belongs to the merchant, the merchant is regarded as a resource transfer-in party, and the authentication information includes a merchant identifier, a merchant address, etc. In some embodiments, the resource transfer terminal displays the authentication information or plays voice information including the authentication information, and the user may check or hear the authentication information.

Then, the near field communication module 12 determines whether a resource transfer order is generated or transmitted according to the stored resource transfer mode of the resource transfer terminal 10 and an online status (in an online state or in an offline state) of the first management terminal (such as the mobile phone of the user). In response to the resource transfer mode of the resource transfer terminal 10 being a fixed amount transfer mode and the first management terminal being offline, the near field communication module 12 generates and stores the resource transfer order according to the stored fixed amount and user signature corresponding to the user identifier, and a transfer-in party signature stored in the resource transfer terminal 10, and outputs feedback information about the successful acceptance of the resource transfer order.

In some embodiments, the resource transfer terminal belongs to a merchant. During trading between the user and the merchant, the merchant is regarded as the resource transfer-in party, the merchant signature is the transfer-in party signature, and the transfer-in party signature is stored in the resource transfer terminal 10. In some embodiments, the transfer-in party signature and the authentication information are sent to the resource transfer terminal by the second management terminal of the merchant, and are stored by the resource transfer terminal.

In some embodiments, the resource transfer signal includes an online status of the first management terminal and the user signature corresponding to the user identifier, so that the near field communication module 12 determines the online status of the first management terminal and the user signature.

In some embodiments, the resource transfer order includes the user identifier, the merchant identifier and the fixed amount of resource transfer. The transfer-out party (with the user identifier), the transfer-in party (with the merchant identifier) and a resource transfer amount (fixed amount) can be determined according to the resource transfer order, and thus the resources of the transfer-out party can be transferred to the transfer-in party. Additionally, the resource transfer order may further include the transfer-out party signature (e.g., the user signature) and the transfer-in party signature (e.g., the merchant signature). Through verification on the signature and the transfer-in party signature, the resource transfer is performed after the verification has passed, and thus the resource transfer security can be improved.

In some embodiments, if the resource transfer terminal stores the resource transfer order, it represents that the resource transfer order is accepted and waits for resource transfer, and the resource transfer can be performed subsequently according to the resource transfer order. in some embodiments, the resource transfer terminal displays feedback information about on successful acceptance of the resource transfer order acceptance, or plays voice information including the feedback information so as to notify the user and the merchant that the resource transfer order has been accepted.

Finally, the resource transfer terminal 10 transmits the resource transfer order to a resource transfer management server in real time or in a preset time period through a second management terminal of a merchant to complete the ordered resource transfer. For example, the resource transfer terminal 10 sends one or more stored resource transfer orders stored to the second management terminal every preset or fixed period so that the resource transfer order will be received by the resource transfer management server through the second management terminal, thus realizing periodical resource transfer.

In some embodiments, when the merchant reads the resource transfer order stored in the resource transfer terminal 10 through the second management terminal (such as a mobile phone with a built-in near field communication module), the built-in near field communication module of the second management terminal transmits an electromagnetic signal carrying a resource transfer order obtaining request, and the near field communication module 12 senses the electromagnetic signal to generate an induced voltage under the effect of the electromagnetic signal, and starts and operates. The near field communication module obtains the request by analyzing the received electromagnetic signal, and outputs a self-stored resource transfer order. The second management terminal obtains the resource transfer order, and performs a resource transfer operation on the basis of the resource transfer order.

By using the above scheme, during trading between the user and the merchant, if the resource transfer cannot be immediately performed since the first management terminal held by the user is in an offline state, the resource transfer terminal can be firstly communicated with the first management terminal to store the resource transfer order, so as to realize the acceptance on the resource transfer order. Subsequently, the resource transfer terminal is communicated with the second management terminal to perform resource transfer according to the resource transfer order to complete the resource transfer operation. In this way, the resource transfer order can be processed by the first management terminal in an offline state. For example, when the first management terminal (e.g., the mobile phone) of the user cannot be connected to the network, the resource transfer (e.g., payment) via the mobile phone can be realized by using the scheme of the present embodiment.

In some embodiments, the housing 11 may be made of any hard materials, such as wood, metal, glass and hard plastics. The near field communication module 12 is attached to a surface of the housing 11. For example, the near field communication module 12 is bonded onto an outer surface of the housing 11, so that the near field communication module 12 is attached to the surface of the housing 11, or the near field communication module 12 is embedded in the housing 11.

In some embodiments, the housing 11 has a card-like shape, is small in size and is portable. In the related art, the resource transfer terminal is generally used as a card reader for reading electronic wallet or bank account information in the terminal to generate a resource transfer order, and then transmits the resource transfer order to a bank or other resource transfer servers through a network to complete resource transfer. However, the terminal can only complete the resource transfer under the network connected condition, and needs to be connected with a power supply. Such conventional terminal has a big size, high cost and\inflexibility in use, and is not easy to be deployed at various use environments.

The resource transfer terminal disclosed in the embodiment of this application performs resource transfer-related data transmission with a first management terminal of a user through the near field communication module disposed in the housing, and can complete resource transfer order acceptance under the offline state/condition of the first management terminal. In this way, the problems of high cost, inflexibility in use and obstacle for deployment in various environment of the conventional resource transfer terminal can be solved.

In the related art, a common resource transfer terminal, such as a point of sale (POS) machine, needs to be connected with a network to accept a resource transfer request of a user, usage scenarios are limited, and the resource transfer order of the user cannot be accepted under the condition that the mobile phone of the user or the POS machine of the merchant is not connected with a network. Additionally, the resource transfer terminal needs a power adapter and a built-in network communication module, is generally provided with a display screen, and has a bigger size and higher cost.

The resource transfer terminal disclosed in this embodiment of this application has a simple structure and a small size. Additionally, the resource transfer terminal disclosed in this embodiment of this application does not need to include a built-in power supply, does not need a power adaptor or a built-in network communication module, does not need to be connected with a network, and only nee ds to include a near field communication module, so that the size is small, the cost is low, and the applications in various use environment are facilitated. Additionally, the requirements on an application environment are lower. The resource transfer terminal can be used in more usage scenarios, is more flexible in use, and is very suitable for wide deployment.

### Embodiment 2

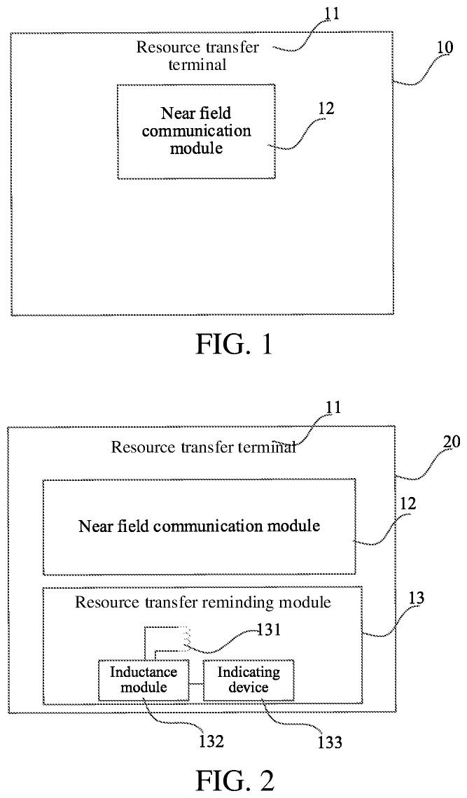

In some embodiments, as shown in FIG. 2, a resource transfer terminal 20 further includes a resource transfer reminding module 13. The resource transfer reminding module 13 operates in a passive mode. In some embodiments, the resource transfer reminding module 13 may be configured to have a circuit structure shown in FIG. 2. The resource transfer reminding module 13 includes an inductance antenna 131, an inductance module 132 electrically connected with the inductance antenna 131, and an indicating device 133 electrically connected with the inductance module 132.

When a near field communication module of a first management terminal of a user transmits a resource transfer signal, similarly to the near field communication module 12, the resource transfer reminding module 13 may also generate an induced voltage under the effect of the electromagnetic signal, and then starts and operates to remind the user that the resource transfer terminal 10 is accepting a resource transfer order. Therefore, under the offline state/condition of the first management terminal, acceptance of the resource transfer order can still be completed through the near field communication module 12, and resource transfer reminder is performed through the resource transfer reminding module 13.

In some embodiments, when the user performs a read-write operation on the resource transfer terminal 10 through the first management terminal with a built-in near field communication module, the inductance antenna 131 receives a resource transfer signal transmitted by the near field communication module of the first management terminal. The inductance module 132 outputs an induced voltage under the effect of the resource transfer signal detected by the inductance antenna 131 to supply electricity to the indicating device 133 electrically connected with the inductance module 132. In some embodiments, the indicating device 133 includes an LED lamp or a film buzzer. Under the condition that the indicating device 133 includes the LED lamp, the LED lamp flickers under the effect of the induced voltage to remind the user that the resource transfer terminal 10 is accepting the resource transfer order. Under the condition that the indicating device 133 includes the film buzzer, the film buzzer gives out sound under the effect of the induced voltage to remind the user that the resource transfer terminal 10 is accepting the resource transfer order. Reminding is performed by triggering the LED lamp or the film buzzer through the induced voltage, so that a size and a thickness of the resource transfer terminal 10 can be reduced, and the cost is reduced. Additionally, electricity consumption of the LED lamp and the film buzzer is low, the reminding time on the user can be prolonged, and the improvement of user experience is facilitated.

### Embodiment 3

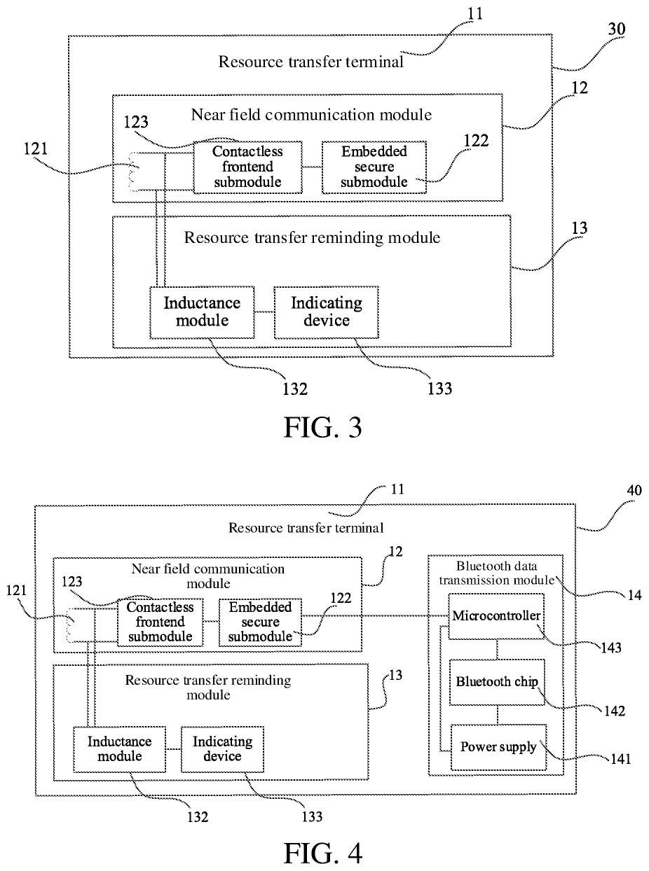

In some embodiments, a resource transfer terminal 30 uses a circuit structure shown in FIG. 3. The near field communication module 12 further includes a radio frequency antenna 121. The resource transfer reminding module 13 further includes an inductance module 132 electrically connected with the radio frequency antenna 121, and an indicating device 133 electrically connected with the inductance module 132. The indicating device 133 includes an LED lamp or a film buzzer.

When the near field communication module of the first management terminal of the user transmits a resource transfer signal, the radio frequency antenna 121 receives the resource transfer signal transmitted by the near field communication module of the first management terminal. The inductance module 132 is electrically connected with the radio frequency antenna 121, so that an induced voltage can be output under the effect of the resource transfer signal detected by the radio frequency antenna 121, and electricity is supplied to the indicating device 133 electrically connected with the inductance module 132.

In some embodiments, the near field communication module 12 further includes a radio frequency antenna 121, an embedded secure submodule 122 and a contactless frontend submodule 123. The contactless frontend submodule 123 is electrically connected with the radio frequency antenna 121.

By sharing the radio frequency antenna 121 by the inductance module 132 and the contactless frontend submodule 123 to receive a sensing signal, the cost of the resource transfer terminal 10 can be further reduced.

### Embodiment 4

According to the resource transfer terminal based on any one of Embodiment 1 to Embodiment 3, as shown in FIG. 4, a resource transfer terminal 40 further includes a Bluetooth data transmission module 14 electrically connected with the near field communication module 12.

This embodiment illustrates a structure of the resource transfer terminal 40 by adding the Bluetooth data transmission module 14 on the basis of the resource transfer terminal 30 shown in FIG. 3 as an example. In some embodiments, as shown in FIG. 4, the Bluetooth data transmission module 14 includes a power supply 141, a Bluetooth chip 142 and a microcontroller 143. The microcontroller 143 is electrically connected with an embedded secure submodule 122 through an I2C interface or an SPI.

In some embodiments, the Bluetooth data transmission module 14 is configured to perform data transmission with a second management terminal of a merchant through Bluetooth communication. The second management terminal of the merchant is a mobile phone or other terminals with a built-in Bluetooth module. The merchant can perform data interaction, such as transmission of a resource transfer key or a verification key, a transfer-in party signature, authentication information of the transfer-in party, a user blacklist and the like to the resource transfer terminal 40, and setting of a resource transfer mode of the resource transfer terminal 40, with the resource transfer terminal 40 through the second management terminal with the Bluetooth module. The Bluetooth data transmission module 14 is further configured to read, by the second management terminal, a successfully accepted resource transfer order stored in the resource transfer terminal 40 through Bluetooth communication.

By disposing the Bluetooth data transmission module 14 in the resource transfer terminal 40, compatibility with the second management terminal with the Bluetooth module, such as a Bluetooth mobile phone, may be realized, so that the resource transfer terminal 40 may be communicated with the terminal with the near field communication module through the near field communication module, and may also be communicated with the terminal with a Bluetooth data transmission module through the Bluetooth data transmission module, and the compatibility of the resource transfer terminal 40 is further improved.

In some embodiments, a housing 11 of the resource transfer terminal 40 in the above embodiment has a card-like shape. The near field communication module 12, the resource transfer reminding module 13 and the Bluetooth data transmission module 14 are embedded in the housing 11. Optionally, the power supply 141 is a button battery. A thickness of the housing 11 is matched with a thickness of the button battery. For example, the thickness of the housing 11 is about 5 mm. The size of the resource transfer terminal 40 is further reduced by adopting the embedded module and the smaller-size button battery.

### Embodiment 5

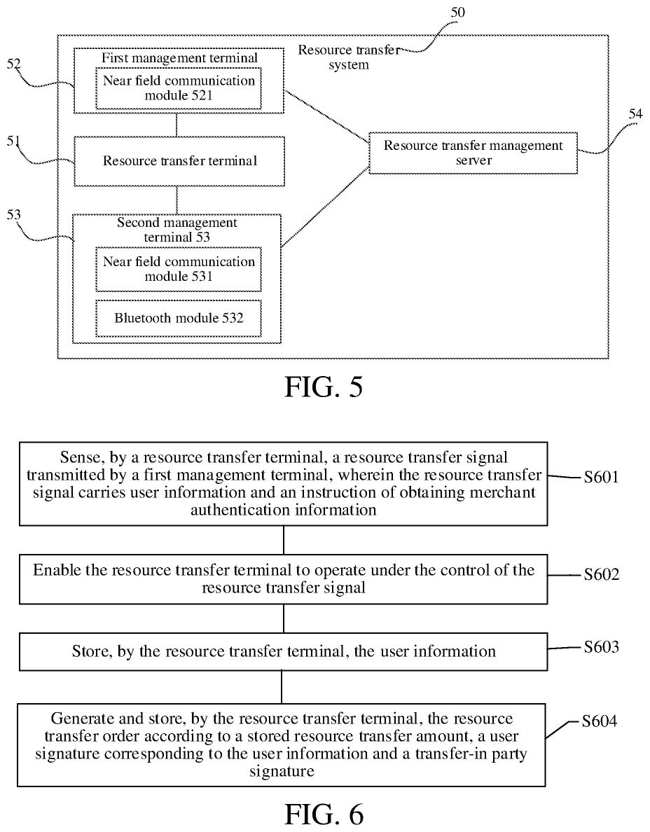

This embodiment discloses a resource transfer system. As shown in FIG. 5, the resource transfer system 50 includes a resource transfer terminal 51, a first management terminal 52, a second management terminal 53 and a resource transfer management server 54. In some embodiments, the resource transfer terminal 51 is any one resource transfer terminal 10, 20, 30 or 40 according to the above embodiments.

The first management terminal 52 reads any one or more of authentication information of a resource transfer-in party, a transfer-in party signature stored in the resource transfer terminal 51, and a resource transfer order generated by the resource transfer terminal 51 through near field communication.

The second management terminal 53 reads the resource transfer order stored in the resource transfer terminal 51 through near field communication or Bluetooth communication, and writes resource transfer-related information into the resource transfer terminal 51.

The resource transfer management server 54 includes at least one server, and performs data transmission with the first management terminal 52 and the second management terminal 53 through a network.

In some embodiments, as shown in FIG. 5, a near field communication module 531 or a Bluetooth module 532 is built in the second management terminal 53. The Bluetooth module 532 may be an integrated chip of a Bluetooth chip and a microcontroller, and may also be a circuit module formed by a Bluetooth chip and a microcontroller which are independently encapsulated. For example, the second management terminal 53 may be intelligent equipment with the built-in near field communication module 531 or the Bluetooth module 532, such as a mobile phone, a POS machine, a tablet computer and intelligent sound equipment.

In some embodiments, a near field communication module 521 is built in the first management terminal 52. For example, the first management terminal 52 is intelligent device with the built-in near field communication module 521, such as a mobile phone, a tablet computer and intelligent sound equipment.

In some embodiments, a near field communication module is built in the resource transfer terminal 51 and the example embodiments of the near field communication module built in the resource transfer terminal 51 are illustrated in FIGS. 1-4. The resource transfer terminal 51 may be communicated with the first management terminal 52 with the built-in near field communication module 521 through the near field communication module, and may also be communicated with the second management terminal 53 with the built-in near field communication module 531 through the near field communication module.

In some embodiments, a Bluetooth data transmission module is further built in the resource transfer terminal 51. The resource transfer terminal 51 may be communicated with the second management terminal 53 with the built-in Bluetooth module 532 through the Bluetooth data transmission module.

An operating flow process of the resource transfer system of this embodiment is as follows.

Step S1: A merchant performs registration on the resource transfer management server 54 through the second management terminal 53, and applies for the resource transfer terminal 51.

In some embodiments, after the second management terminal 53 of the merchant completes the registration on the resource transfer management server 54, the resource transfer management server 54 may cause the resource transfer terminal 51 to be distributed to the merchant who owns the second management terminal 53 which has been successfully registered. The resource transfer terminal 51 is provided with a verification key configured for the resource transfer management server 54 to manage the resource transfer terminal 51, or configured for the first management terminal 52 and the second management terminal 53 to perform device verification on the resource transfer terminal 51.

In some embodiments, the second management terminal 53 needs to upload self-related merchant information, such as a merchant name, resource receiving account information or an icon during the registration on the resource transfer management server 54. The resource transfer management server 54 generates a key according to the merchant information uploaded by the second management terminal 53. The key includes a resource transfer key and/or a verification key, and is transmitted to the second management terminal 53. The second management terminal 53 transmits the key generated by the resource transfer management server 54 to the resource transfer terminal 51 and is stored at the resource transfer terminal 51.

Step S2: The second management terminal 53 applies for opening an order resource transfer function through the resource transfer terminal 51 from the resource transfer management server 54.

The second management terminal 53 transmits a request of applying for opening a resource transfer function to the resource transfer management server 54 through a network. Additionally, the second management terminal 53 may also apply for opening order resource transfer modes such as online resource transfer mode or offline resource transfer mode.

Step S3: The second management terminal 53 transmits the key and/or the order resource transfer mode to the resource transfer terminal 51 through near field communication.

In some embodiments, the second management terminal 53 transmits resource transfer-related information issued by the resource transfer management server 54 to the resource transfer terminal 51 to be stored through near field communication. The resource transfer-related information includes, but is not limited to, any one or more of the followings: the key, the order resource transfer amount, and the order resource transfer mode.

Step S4: The first management terminal 52 transmits an instruction of obtaining the authentication information stored in the resource transfer terminal 51 through near field communication.

In some embodiments, during ordering resource transfer by the resource transfer terminal 51, the first management terminal 52 needs to be firstly registered on the resource transfer management server 54, and then obtain a unique user identifier transmitted by the resource transfer management server 54 to the first management terminal 52. The user identifier is configured to represent the identity of the user of the first management terminal.

Then, the first management terminal 52 transmits an instruction of obtaining the authentication information of the transfer-in party stored in the resource transfer terminal 51 through near field communication. In some embodiments, the instruction of obtaining the authentication information stored in the resource transfer terminal 51 includes a user identifier. In some embodiments, the instruction of obtaining the authentication information stored in the resource transfer terminal 51 may further include information indicating whether the first management terminal 52 is online, i.e., the online status of the first management terminal 52, such as an online state or an offline state.

Step S5: The resource transfer terminal 51 of the merchant obtains the user identifier of a current login user in the first management terminal 52 according to the triggering or activation of the first management terminal 52.

Step S6: The resource transfer terminal 51 judges whether a fixed amount transfer mode is opened. If YES, step S7 is performed. Otherwise, step S8 is performed.

Step S7: When it is determined that the resource transfer terminal 51 has opened the fixed amount transfer mode, the resource transfer terminal 51 generates a resource transfer order according to a set fixed amount.

When it is determined that the resource transfer terminal 51 has set a fixed amount transfer mode, the resource transfer terminal 51 generates a resource transfer order according to the set fixed amount, then, the operation jumps to step S11, and the generated resource transfer order is encrypted, and is stored locally in the resource transfer terminal 51.

Step S8: The resource transfer terminal 51 outputs the authentication information.

Step S9: The first management terminal 52 generates a resource transfer order according to an operation of the user, and transmits the resource transfer order through near field communication.

Step S10: The resource transfer terminal 51 receives the resource transfer order transmitted by the first management terminal 52 through near field communication.

Step S11: The resource transfer terminal 51 adds a transfer-in party signature and a user signature to the resource transfer order, and stores the resource transfer order after signature addition.

Step S12: The resource transfer terminal 51 transmits a resource transfer order acceptance state to the first management terminal 52 through near field communication.

So far, the user completes offline resource transfer once with the transfer-in party (e.g., the merchant) through the terminal with the built-in near field communication module, and the acceptance on the resource transfer order is realized.

Step S13: The second management terminal 53 obtains the resource transfer order stored in the resource transfer terminal 51 through near field communication. The resource transfer order is a resource transfer order generated when the first management terminal 52 performs resource transfer to the merchant in an offline state.

Step S14: The second management terminal 53 transmits the resource transfer order to the resource transfer management server 54 through a network.

Step S15: The resource transfer management server 54 analyzes the resource transfer order, and completes the resource transfer of the amount corresponding to the resource transfer order.

The resource transfer management server 54 performs decryption on the received resource transfer order according to the key applied for by the second management terminal 53, analyzes the resource transfer order, determines the resource transfer user, the merchant and the resource transfer amount, and finally transfers the corresponding amount from an account of the user to an account of the merchant.

### Embodiment 6

As shown in FIG. 6, this application further provides a resource transfer method. In step S601, a resource transfer terminal senses a resource transfer signal transmitted by a first management terminal. The resource transfer signal carries user information and an instruction of obtaining authentication information.

In step S602, the resource transfer terminal operates under the control of the resource transfer signal.

In step S603, the resource transfer terminal stores the user information.

In step S604, the resource transfer terminal generates and stores a resource transfer order according to a stored resource transfer amount, a user signature corresponding to the user information, and a transfer-in party signature.

The resource transfer terminal may further determine whether a fixed amount transfer mode is opened. If YES, the resource transfer order is generated and stored according to the stored fixed amount, the user signature corresponding to the user information and the transfer-in party signature. If NO, the authentication information is output.

If the resource transfer terminal determines that the first management terminal is in an offline state according to the resource transfer signal, the resource transfer order is generated and stored according to the stored resource transfer amount, the user signature corresponding to the user information and the transfer-in party signature. If the resource transfer terminal determines that the first management terminal is in an online state according to the resource transfer signal, the authentication information is output.

The resource transfer terminal may further output reminding information indicating that the resource transfer order has been accepted.

According to the resource transfer system of this application, the resource transfer terminal, the first management terminal and the second management terminal perform resource transfer order transmission through near field communication. Then, the order resource transfer is completed by the second management terminal and the resource transfer management server through the network, so that the order of the user can be accepted under the offline condition of the user. The final order settlement is further completed through the second management terminal of the merchant. Additionally, the user and the merchant do not need to be connected with the network in the trading process of the user and the merchant, and can be used in various environments for performing the resource transfer such as settings without network. The resource transfer terminal disclosed in the embodiments of this application has a board-like or card-like shape, the structure is simple, and the size is small. Additionally, the resource transfer terminal disclosed in the embodiments of this application works without a built-in power supply, does not need a power adapter, does not need a built-in network communication module, does not need to be connected with the network, and only needs to include a near field communication module. Because of its small size and low cost, the resource transfer terminal of the present disclosure can be used widely in various use environments. The requirements on an application environment is low. The resource transfer terminal disclosed in the embodiments of this application can be used in more usage scenarios, is more flexible in use, and is very suitable for wide deployment. Additionally, the first management terminal and the second management terminal are optionally mobile phones, and the merchant does not need to buy other special equipment, so that the cost of the merchant is reduced to a great degree, and the popularization of the resource transfer system is facilitated.

It will be appreciated by those of ordinary skill in the art that in the embodiments provided in this application herein, units described as separate components may or may not be physically separate. Additionally, some of the modules in each embodiment of this application may be replaced with an integrated chip.

The foregoing descriptions are merely specific implementations of this application, but are not intended to limit the protection scope of this application. Any variation or replacement readily figured out by a person skilled in the art without creative efforts within the technical scope disclosed in this application shall fall within the protection scope of this application. Therefore, the protection scope of this application shall be subject to the protection scope of the claims.

What is claimed is:

1. A resource transfer terminal, comprising:
a housing; and
a near field communication module, supported by the housing, configured to be operable in a passive mode and provided with a resource transfer key and/or a verification key;
wherein the near field communication module operates in response to a sensed resource transfer signal transmitted by a device of a resource transfer-out party.

2. The resource transfer terminal according to claim 1, wherein the near field communication module is attached to a surface of the housing; or the near field communication module is embedded in the housing.

3. The resource transfer terminal according to claim 1, further comprising: a resource transfer reminding module embedded in the housing and operable in the passive mode.

4. The resource transfer terminal according to claim 3, wherein the near field communication module further comprises a radio frequency antenna; and the resource transfer reminding module further comprises an inductance module electrically connected with the radio frequency antenna, and an indicating device electrically connected with the inductance module.

5. The resource transfer terminal according to claim 3, wherein the resource transfer reminding module comprises: an inductance antenna; an inductance module electrically connected with the inductance antenna; and an indicating device electrically connected with the inductance module.

6. The resource transfer terminal according to claim 4, wherein the indicating device comprises any one or more of the followings: an LED lamp; and a film buzzer.

7. The resource transfer terminal according to claim 1, further comprising a Bluetooth data transmission module electrically connected with the near field communication module.

8. The resource transfer terminal according to claim 7, wherein the near field communication module further comprises an embedded secure submodule; the Bluetooth data transmission module further comprises a power supply, a Bluetooth chip and a microcontroller; and the microcontroller is electrically connected with the embedded secure submodule through an I2C interface or an SPI.

9. The resource transfer terminal according to claim 1, wherein the housing has a card-like shape.

10. The resource transfer terminal according to claim 1, wherein the resource transfer terminal is a terminal by a resource transfer-in party and the resource transfer-in party is a merchant and wherein the resource transfer signal is a payment signal and payment signal includes an online status of the device of the resource transfer-out party.

11. A resource transfer system, comprising:
a resource transfer terminal;
a first management terminal of a resource transfer-out party;
a second management terminal of a resource transfer-in party; and
a resource transfer management server;
wherein the first management terminal reads any one or more of authentication information of the resource transfer-in party and a resource transfer-in party signature stored in the resource transfer terminal, and a resource transfer order generated by the resource transfer terminal through near field communication;
the second management terminal reads the resource transfer order stored in the resource transfer terminal through near field communication or Bluetooth communication, and writes resource transfer-related information into the resource transfer terminal; and
the resource transfer management server performs data transmission with the first management terminal and the second management terminal through a network.

12. The resource transfer system according to claim 11, wherein the second management terminal includes a built-in near field communication module or a built-in Bluetooth module.

13. The resource transfer system according to claim 12, the first management terminal includes a built-in near field communication module.

14. The resource transfer system according to claim 13, wherein the resource transfer terminal includes a near field communication module and is configured to be operable in a passive mode and is provided with a resource transfer key.

15. A resource transfer method, comprising:
sensing, by a resource transfer terminal, a resource transfer signal transmitted by a first management terminal of a user, wherein the resource transfer signal carries user information and an instruction of obtaining authentication information of a resource transfer-in party;
enabling the resource transfer terminal to operate in response to the resource transfer signal via near field communication;
storing, by the resource transfer terminal, the user information; and
generating and storing, by the resource transfer terminal, a resource transfer order according to a stored resource transfer amount, a user signature corresponding to the user information and a transfer-in party signature.

16. The resource transfer method according to claim 15, further comprising:
determining, by the resource transfer terminal, whether to open a fixed amount resource transfer mode;
in response to a determination of opening the fixed amount resource transfer mode, generating and storing the resource transfer order according to the stored resource transfer amount, the user signature corresponding to the user information and the transfer-in party signature; and
in response to a determination of not opening the fixed amount resource transfer mode, outputting authentication information of the resource transfer-in party.

17. The resource transfer method according to claim 15, further comprising:
in response to a determination, by the resource transfer terminal, that the first management terminal is in an offline state according to the resource transfer signal, generating and storing the resource transfer order according to the stored resource transfer amount, the user signature corresponding to the user information and the transfer-in party signature; and
in response to a determination, by the resource transfer terminal, that the first management terminal is in an online state according to the resource transfer signal, outputting authentication information of the resource transfer-in party.

18. The resource transfer method according to claim 15, further comprising:
outputting, by the resource transfer terminal, reminding information indicating that the resource transfer order has been accepted.

19. The resource transfer method according to claim 15, wherein the resource transfer terminal is a payment merchant terminal owned by a merchant, the first management terminal is an intelligent device of a.

20. The resource transfer method according to claim 15, wherein the resource transfer-in party is a merchant.
